(19) United States
(12) Patent Application Publication
(10) Pub. No.: US 2017/0313229 A1
(43) Pub. Date: Nov. 2, 2017

(54) RETRACTABLE SHELF SYSTEM ADAPTED FOR USE WITH A MOTOR VEHICLE DOOR

(71) Applicant: Kevin ISERNIO, Huntington, NY (US)

(72) Inventor: Kevin ISERNIO, Huntington, NY (US)

(21) Appl. No.: 15/141,377

(22) Filed: Apr. 28, 2016

(51) Int. Cl. B60N 3/00; B60R 11/00

(52) U.S. Cl. CPC B60N 3/007; B60R 2011/0021; B60R 2011/0082

(57) ABSTRACT

A retractable shelf system for use with a motor vehicle is provided. The retractable shelf system includes a microcontroller, a rail assembly operably disposed within a door of the motor vehicle and in operable communication with the microcontroller, which is configured to control the rail assembly, and a retractable shelf including a hinge assembly that is operably coupled to the rail assembly and in operable communication with the microcontroller for moving the retractable shelf from a stowed configuration disposed within the door of the motor vehicle to an un-stowed configuration disposed outside of the door of the motor vehicle, wherein in the un-stowed configuration the retractable shelf is rotatable from a vertical configuration to a horizontal configuration.

### BACKGROUND

### Field of the Disclosure

The present disclosure relates generally to a retractable shelf system that is adapted for use with a motor vehicle door, and more particularly, to a retractable (extendable) shelf system that includes a retractable shelf that is movable from stowed configuration to an un-stowed configuration whereby the retractable shelf is rotatable from a vertical configuration to a horizontal configuration.

### Description of the Related Art

Conventional motor vehicle doors are well known in the art. Typically, the doors include an armrest and one or more buttons that allow a user to control one or more functions associated with the door, e.g., door locks, windows, etc.

However, conventional doors do not provide a retractable shelf that is movable from a stowed configuration to an un-stowed configuration. In the un-stowed configuration, the retractable shelf can be used by a user to carry out one or more specific tasks. For example, the retractable shelf can be used by a user to support a laptop (or smart device, e.g., a tablet, phone, etc.), food, or other item, thereby offering the user a sturdy surface to work, eat, and or read in the environment of a vehicle.

### SUMMARY

As can be appreciated, a retractable shelf system that includes a retractable shelf that is movable from stowed configuration to an un-stowed configuration whereby the retractable shelf is rotatable from a vertical configuration to a horizontal configuration may prove useful in the automotive industry.

Embodiments of the present disclosure are described in detail with reference to the drawing figures wherein like reference numerals identify similar or identical elements. As used herein, the term “distal” refers to the portion that is being described which is further from a user, while the term “proximal” refers to the portion that is being described which is closer to a user.

In accordance with an aspect of the present disclosure a retractable shelf system for use with a motor vehicle is provided. The retractable shelf system includes a microcontroller, a rail assembly, and a retractable shelf. The rail assembly is operably disposed within a door of the motor vehicle and is in operable communication with the microcontroller, which is configured to control the rail assembly. The retractable shelf includes a hinge assembly that is operably coupled to the rail assembly and is in operable communication with the microcontroller for moving the retractable shelf from a stowed configuration disposed within the door of the motor vehicle to an un-stowed configuration disposed outside of the door of the motor vehicle. In the un-stowed configuration, the retractable shelf is rotatable from a vertical configuration to a horizontal configuration.

In accordance with an aspect of the present disclosure a retractable shelf system for use with a motor vehicle is provided. The retractable shelf system includes a microcontroller, a rail assembly, and an automatic retractable shelf. The rail assembly is operably disposed within a door of the motor vehicle and is in operable communication with the microcontroller, which is configured to control the rail assembly. The automatic retractable shelf includes a hinge assembly that is operably coupled to the rail assembly and is in operable communication with the microcontroller for moving the retractable shelf, upon actuation of at least one first button, from a stowed configuration disposed within the door of the motor vehicle to an un-stowed configuration disposed outside of the door of the motor vehicle. In the un-stowed configuration, the retractable shelf is rotatable, upon actuation of at least one second button, from a vertical configuration to a horizontal configuration.

### BRIEF DESCRIPTION OF THE DRAWING

Various embodiments of the present disclosure are described hereinbelow with references to the drawings, wherein:

FIG. 1 is a perspective view of a door of a motor vehicle including a retractable shelf system shown in a stowed configuration, according to an embodiment of the present disclosure;

FIG. 2 is a perspective view of the door of the motor vehicle including the retractable shelf system shown in an un-stowed and vertical configuration (i.e. the mid-transformation phase), according to an embodiment of the present disclosure;

FIG. 3 is a partial, perspective view of the door of the motor vehicle including the retractable shelf system shown in a horizontal configuration after rotating approximately ninety degrees from the orientation shown in FIG. 2, according to an embodiment of the present disclosure;

FIG. 4 is a perspective view of a retractable shelf including a hinge assembly that is operably coupled to a rail assembly of the retractable shelf system, with the retractable shelf shown in a stowed configuration, according to an embodiment of the present disclosure;

FIGS. 5A-5C are perspective views of components of the hinge assembly shown in various configurations, according to an embodiment of the present disclosure; and

FIG. 6 is a perspective view of the retractable shelf including the hinge assembly, with the retractable shelf shown being moved from the stowed configuration to an un-stowed configuration, according to an embodiment of the present disclosure.

### DETAILED DESCRIPTION

Detailed embodiments of the present disclosure are disclosed herein; however, the disclosed embodiments are merely examples of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

As noted above, a retractable shelf system that includes a retractable shelf which is movable from a stowed (retracted/non-extended) configuration to an un-stowed configuration whereby the retractable shelf is rotatable from a vertical configuration to a horizontal configuration may prove useful in the automotive industry, and a description of such a system is herein described.

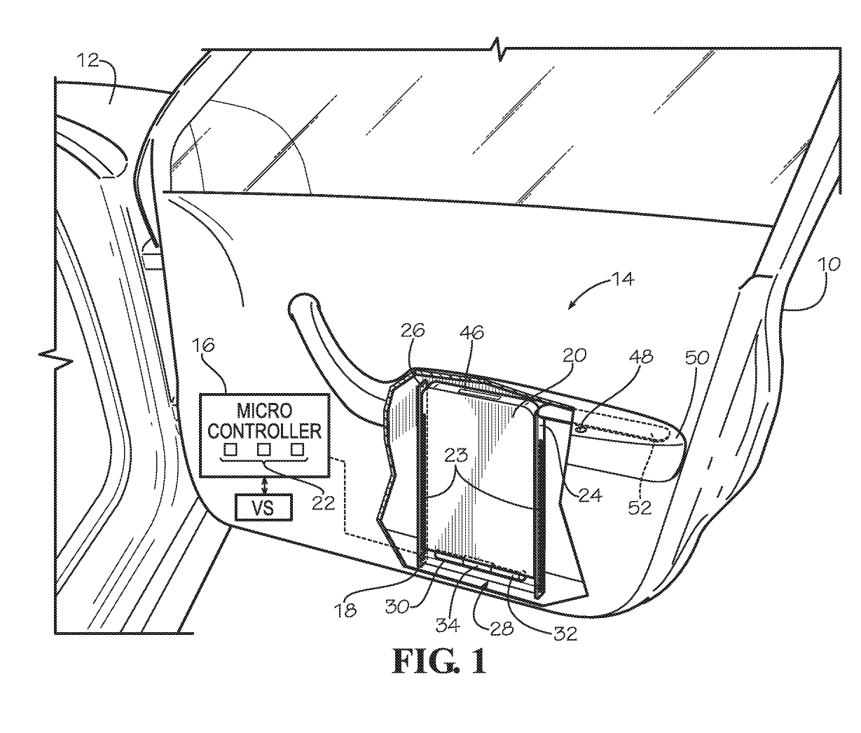

FIG. 1 is a perspective view of a door 10 of a motor vehicle 12 including a retractable shelf system 14, which is shown in a stowed configuration, according to an embodiment of the present disclosure. The retractable shelf system 14 includes a microcontroller 16, a rail assembly 18, and a retractable shelf 20.

The microcontroller 16 can be in operable communication with a computer system of the motor vehicle 12, or the microcontroller 16 may be a stand alone component that does not interact with the computer system of the motor vehicle 12. The microcontroller 16 includes one or more modules 22 (e.g., processors, memory, drivers, etc.) that are configured to communicate with the rail assembly 18 and the retractable shelf 20, via one or more suitable wired interfaces, for controlling operation of the retractable shelf 20, as described in greater detail below.

Alternatively, the one or more modules 22 may communicate with the rail assembly 18 and the retractable shelf 20 via a wireless interface, Bluetooth®, NFC, etc.

Continuing with reference to FIG. 1, the rail assembly 18 is operably disposed within the door 10 of the motor vehicle 12 and is in operable communication with the microcontroller 16. The rail assembly 18 includes a pair of upright rails 24 and 26 that are provided behind an interior door panel of the door 10 and are connected therein via one or more connection devices, e.g., bolts, screws, nuts, or other suitable device(s).

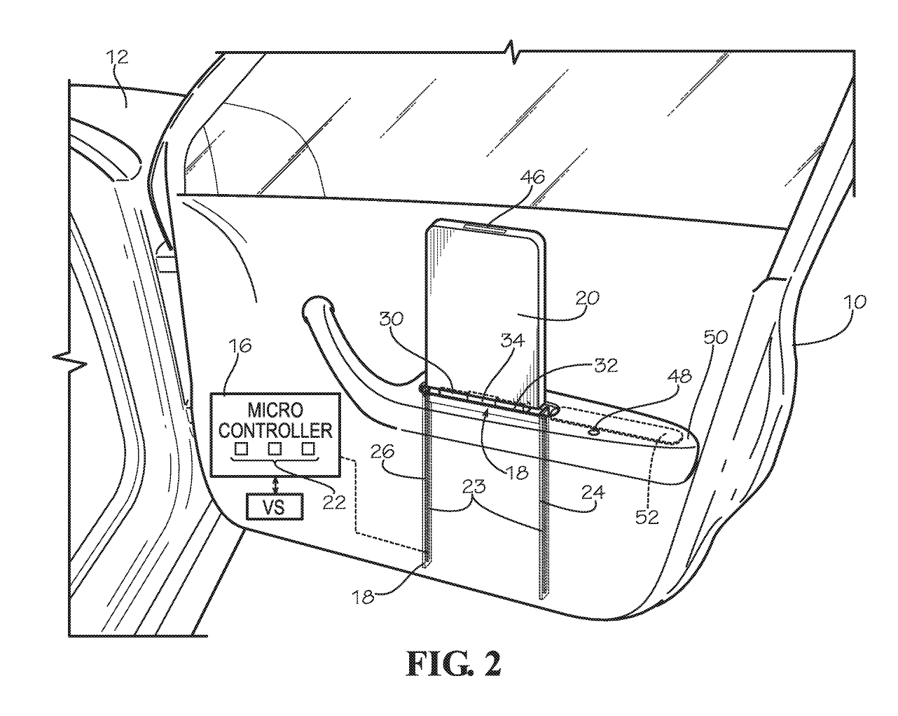

Each of the rails 24, 26 include a drive mechanism 23, e.g., gears, pulleys, wires, motors, etc., that is configured to move the retractable shelf 20 between the stowed configuration (FIG. 1) and the un-stowed configuration (FIG. 2). For clarity, the drive mechanism 23 is shown in phantom in the FIGs; other components may also be used with the rails 24, 26 to move the retractable shelf 20 between the stowed and un-stowed configurations.

The rails 24, 26 connect to the retractable shelf 20 via a hinge assembly 28 that includes a pair of movable hinge components 30 and 32 and a stationary component 34, which are operably connected to a base member 36, which includes a pair of protrusions that connects the hinge assembly 28 to the rails 24, 26.

The pair of movable hinge components 30 and 32 are movable relative to the base member 36, while the stationary component 34 is fixedly attached to the base member 36. One or more coupling methods or devices may be used to couple the pair of movable hinge components 30, 32 to the base member 36. For example, each of the movable hinge components 30, 32 may be coupled to the base member 36 via a right angle arm that includes a vertical component that is fixedly connected to the base member 36 and a horizontal component that couples to the movable hinge components 30, 32, thereby allowing the movable hinge components 30, 32 to rotate about the base member 36 relative to the stationary component 34; however, other coupling methods are contemplated.

One or more other devices may also be connected to the movable hinge components 30, 32 to rotate them about the base member relative to the stationary component 34. For example, one or more motors, solenoids, gears, relays, or other suitable device(s) may be used to rotate the movable hinge components 30, 32 about the base member 36 relative to the stationary component 34.

Each of the movable hinge components 30, 32 includes a movable rod 38, 40, respectively, that is configured to slide into and out of engagement with one or more channels 42 that are disposed on the stationary component 34 (as best seen in FIGS. 5A-5C). For illustrative purposes, the stationary component 34 is shown having four channels 42; more or less channels can be provided. For example, the stationary component 34 may have two channels that extend along the entire length of stationary component 34.

The channels 42 are provided on opposing ends of the stationary component 34. More particularly, a pair of channels 42 are provided on opposing ends of the stationary component 34, and each of the pair of channels 42 are approximately 90 degrees spaced apart from each other so that the retractable shelf 20 can be moved from a vertical configuration to a horizontal configuration, as will be described in more detail below.

A microelectromechanical system (MEMS) 44 that is in operable communication with the microcontroller 16 is provided on each of the movable hinge components 30, 32 (FIGS. 5A-5C). The MEMS 44 is connected to the a movable rod 38, 40 and is used to move the movable rods 38, 40 into and out of engagement with/from a respective one of the channels 42 of the stationary component 34 for locking the retractable shelf 20 in the vertical configuration and for unlocking the retractable shelf 20 so that the retractable shelf 20 can be moved from the vertical configuration to the horizontal configuration.

The MEMS 44 is controlled by the microcontroller 16 which is connected to a button 46, which is located on the retractable shelf 20. For illustrative purposes, the button 46 is shown on a sidewall of the retractable shelf 20 (see FIG. 1 for example); however, the specific position of the button 46 can changed based on a manufacture's preference, user preference, accessories provided on the retractable shelf 20, etc. For example, the button 46 can be provided on a top surface of the retractable shelf 20.

Pressing the button 46 sends a control signal to the microcontroller 16. Upon receiving the control signal from the button 46, the microcontroller 16 instructs the MEMS 44 to move the movable rods 38, 40 into and out of engagement with the respective channels 42, thereby allowing the retractable shelf 20 to be rotated 90 degrees from the vertical configuration to the horizontal configuration.

In addition to the button 46, a button 48 is operably disposed on an armrest 50 of the door 10 and is in operable communication with the microcontroller 16. Actuation of the button 48 automatically opens a panel 52 (which is shown in phantom in the FIGs., see FIG. 1 for example) of the armrest 50. More particularly, actuation of the button 48 moves the panel 52 from a closed configuration to an open configuration and gives space for the retractable shelf 20 to move from the stowed configuration to the un-stowed configuration.

The retractable shelf 20 can be made from any suitable material including, but not limited to, plastic, metal, metal alloy, etc. The retractable shelf 20 can have any suitable shape. For example, the retractable shelf 20 may be circular, rectangular, square, etc. For illustrative purposes, the retractable shelf 20 is shown having a rectangular shape.

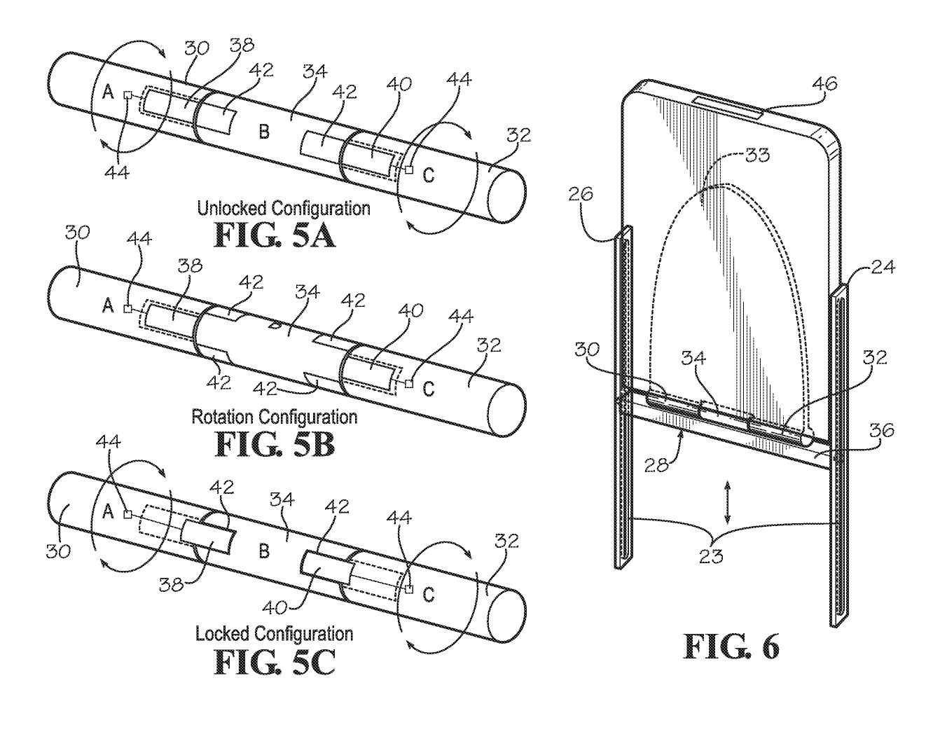

The retractable shelf 20 can be connected to the hinge assembly 28 via one or more suitable connection methods or devices. For example, in the illustrated embodiment, a projection 33 (shown in phantom in FIGS. 4 and 6) can be provided on the movable hinge components 30, 32 and the stationary hinge component 34 and overmolded to the retractable shelf 20. Alternatively, the projection can be seated within a recess or void that is formed within the retractable shelf 20 during a manufacturing process thereof.

It is noted that the movable hinge components 30, 32 and stationary component 34 are shown in FIGS. 5A-5C without the projection 33 being attached thereto, for illustrative purposes.

The retractable shelf 20 can be configured with one or more accessories. For example, the retractable shelf 20 can be provided with an electrical receptacle 54, which can be used for plugging in one or more electronic devices, e.g., a laptop.

The retractable shelf 20 may be provided with a plurality of light sources. For example, a plurality of Light Emitting Diodes (LEDs) 56 may be provided along a perimeter of the retractable shelf 20 and can be used for illuminating the retractable shelf 20.

The retractable shelf 20 can be provided with one or more Universal Serial Bus (USB) ports 58, which can be used for connecting to one or more electronic devices, e.g., a smart phone, tablet, etc.

The retractable shelf 20 can be provided with one or more apertures 60 that are in fluid communication with a vacuum/suction source VS, which is controlled by the microcontroller 16. In this instance, the vacuum source VS is connected to the retractable shelf 20 and can be used to provide suction, via the apertures 60, to the top surface of the retractable shelf 20. This suction can be used to maintain one or more objects, e.g., a piece of paper, which are supported on the retractable shelf 20, in contact with the top surface of the retractable shelf 20. One or more ports can be provided on the retractable shelf 20 and can provide fluid communication between the apertures 60 and the VS, via one or more lumens or channels which can be defined or provided within the retractable shelf 20.

Operation of the retractable shelf system 14 is now described. It is noted that the retractable shelf 20 can be installed into each door (or in at least one door) of the motor vehicle 12, including that of the driver.

In use, the retractable shelf 20 is, initially, in the stowed configuration (retracted configuration) (FIG. 1). To move the retractable shelf 20 from the stowed configuration to the un-stowed configuration (non-retracted), a user can press the button 48, which sends a control signal to the microcontroller 16.

The microcontroller 16 sends a control signal to the panel 52 and the rail assembly 18. Upon receiving the control signal, the panel 52 slides open, and the base member 36 moves vertically between the rails 24, 26, via the drive mechanism 23 (FIG. 6), which, in turn, moves the retractable shelf 20 from the stowed configuration to the un-stowed and vertical configuration (FIGs.1 and 2), i.e., the mid-transformation phase.

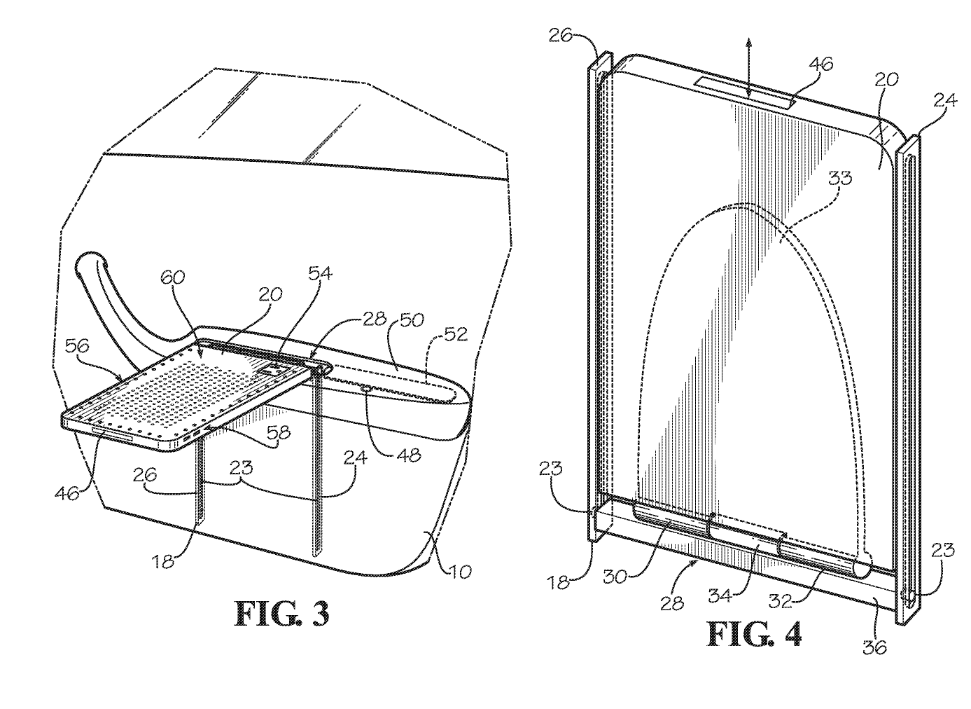

When the retractable shelf 20 is in the vertical configuration, the user can press the button 46 which sends a control signal to the microcontroller 16. Upon receiving the control signal, the microcontroller 16 sends a control signal to the MEMS 44, which, in turn, moves the movable rods 38, 40 out of engagement with the respective channels 42 (FIG. 5A). With the movable rods 38, 40 out of engagement with the respective channels 42, the retractable shelf 20 can be rotated from the vertical configuration to the horizontal configuration (FIGS. 2, 3, and 5B). It is noted that this movement from the vertical configuration to the horizontal configuration can be achieved automatically via the microcontroller 16 or manually by a user. In the latter instance, movement of the retractable shelf 20 is limited so that the movable rods 38, 40 align with the respective channels 42; for example, one or more accelerometers or other device(s) may be used to ensure that movement of the retractable shelf 20 is limited to the horizontal configuration.

With the retractable shelf 20 in the horizontal configuration (un-stowed configuration), the microcontroller 16 sends a control signal to MEMS 44, which, in turn, moves the movable rods 38, 40 back into of engagement with the respective channels 42 (FIG. 5C) to lock the retractable shelf 20 in the horizontal configuration. In the horizontal configuration, a user can place one or more objects, e.g., laptop, food, beverage, etc., on the top surface of the retractable shelf 20, and, if desired, can use one or more of the aforementioned accessories, e.g., the USB port, with the object placed on the top surface of the retractable shelf 20.

To return the retractable shelf 20 back to the stowed configuration, a user can press the button 46 which unlocks the retractable shelf 20 and allows the user to raise the shelf back to the vertical configuration. Once in the vertical configuration, and upon the movable rods 38, 40 relocking, the microcontroller 16 sends a control signal to the rail assembly 18 for lowering the retractable shelf 20, and after the retractable shelf 20 has been lowered, the microcontroller 16 sends a control signal to the panel 52 for closing the panel.

As can be appreciated, the retractable shelf system 14, overcomes the aforementioned drawbacks that are typically associated with motor vehicles that do not include retractable shelf systems. For example, as noted above, the retractable shelf 20 can be used by a passenger of a motor vehicle to support (and charge) a laptop, smart device, etc., can be used to provide a flat sturdy surface for food or drink, or can be used to create a productive environment, thereby allowing a user to conveniently read and write.

From the foregoing and with reference to the various figure drawings, those skilled in the art will appreciate that certain modifications can also be made to the present disclosure without departing from the scope of the same. For example, while the retractable shelf system 14 has been described herein as including a retractable shelf 20, other devices can also be implemented. For example, a retractable desk, a retractable table top, a retractable surface, etc. can also be used in place of the retractable shelf.

The microcontroller 16 can be configured to detect when the motor vehicle 12 is in motion, and, when the microcontroller 16 detects that the motor vehicle 12 is in motion, the microcontroller 16 can disable the retractable shelf system 14, that is, prevent a user from activating the retractable shelf system 14.

Moreover, an override button/mechanism can be provided on the armrest of the driver and used to control operation of a retractable shelf that is provided in another door, e.g., a rear door. For example, in the instance where an occupant is a young child, a driver can lock/control a retractable shelf that is provided in the rear door and accessible to the child.

The microcontroller 16 can be configured to be paired with a smart device, e.g., a smart phone, thereby allowing the smart device to control the retractable shelf system 14.

As a safety feature, the retractable shelf can be configured to automatically detach from the hinge assembly 28 upon a predetermined amount of force being applied to the retractable shelf 20. Thus, in the event that the motor vehicle 12 is involved in a collision (or the motor vehicle 12 comes to an abrupt stop), the retractable shelf 20 would detach from the hinge assembly 28 upon an occupant of the motor vehicle 12 coming into contact with the retractable shelf 20. In the event that the retractable shelf 20 is detached from the hinge assembly 28, a user can simply reattach the retractable shelf 20 to the hinge assembly 28.

In addition to the aforementioned accessories that have been described for use with the retractable shelf 20, other accessories can also be provided. For example, a cup holder slot for receiving a cup can be provided on the top surface of the retractable shelf 20, or a stand for supporting an electronic device, e.g., a smart phone, can also be provided on the top surface of the retractable shelf 20.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A retractable shelf system for use with a motor vehicle, the retractable shelf system comprising:
a microcontroller;
a rail assembly operably disposed within a door of the motor vehicle and in operable communication with the microcontroller, which is configured to control the rail assembly; and
a retractable shelf including a hinge assembly that is operably coupled to the rail assembly and in operable communication with the microcontroller for moving the retractable shelf from a stowed configuration disposed within the door of the motor vehicle to an un-stowed configuration disposed outside of the door of the motor vehicle,
wherein in the un-stowed configuration the retractable shelf is rotatable from a vertical configuration to a horizontal configuration.

2. The retractable shelf system according to claim 1, further comprising:
at least one first button that is operably disposed on an armrest of the door and is in operable communication with the microcontroller such that actuation of the at least one first button automatically opens a panel of the armrest and moves the retractable shelf from the stowed configuration to the un-stowed configuration; and
at least one second button that is operably disposed on the at least one retractable shelf and is in operable communication with the microcontroller such that actuation of the at least one second button automatically moves the at least one retractable shelf from the vertical configuration to the horizontal configuration.

3. The retractable shelf system according to claim 2 wherein the hinge assembly comprises:
a pair of movable hinge components each having at least one movable rod;
a stationary component having at least one channel that is configured to receive the at least one movable rod of at least one of the movable hinge components; and
a microelectromechanical system (MEMS) that is in operable communication with the microcontroller and the at least one second button for moving the at least one movable rod of at least one of the movable hinge components into engagement with the at least one channel of the stationary component for locking the retractable shelf in the vertical configuration and moving the at least one movable rod of at least one of the of movable hinge components out of engagement with the at least one channel of the stationary component for unlocking the retractable shelf so that the retractable shelf can be moved from the vertical configuration to the horizontal configuration.

4. The retractable shelf system according to claim 1, wherein the rail assembly comprises a pair of rails each supporting an end of a base member that is operably connected to the hinge assembly of the retractable shelf, and
wherein the base member is movable between the pair of rails along a vertical axis for moving the retractable shelf from the stowed configuration to the un-stowed configuration.

5. The retractable shelf system according to claim 1, further comprising at least one universal serial bus port that is disposed on the retractable shelf.

6. The retractable shelf system according to claim 1, further comprising a plurality of light sources that are arranged around a perimeter of the retractable shelf for illuminating a top surface of the retractable shelf.

7. The retractable shelf system according to claim 1, wherein the microcontroller is configured to detect when the motor vehicle is in motion, and, when the microcontroller detects that the motor vehicle is in motion, disable the retractable shelf system.

8. The retractable shelf system according to claim 1, wherein microcontroller is configured to pair with a smart device for allowing the smart device to control the retractable shelf system.

9. The retractable shelf system according to claim 1, wherein in the horizontal configuration the retractable shelf is configured to detach from the hinge assembly upon a predetermined amount of force being applied to the retractable shelf.

10. A retractable shelf system for use with a motor vehicle, the retractable shelf system comprising:
a microcontroller;
a rail assembly operably disposed within a door of the motor vehicle and in operable communication with the microcontroller, which is configured to control the rail assembly;
an automatic retractable shelf including a hinge assembly that is operably coupled to the rail assembly and in operable communication with the microcontroller for moving the retractable shelf, upon actuation of at least one first button, from a stowed configuration disposed within the door of the motor vehicle to an un-stowed configuration disposed outside of the door of the motor vehicle,
wherein in the un-stowed configuration the retractable shelf is rotatable, upon actuation of at least one second button, from a vertical configuration to a horizontal configuration.

11. The retractable shelf system according to claim 10, wherein the at least one first button is operably disposed on an armrest of the door and is in operable communication with the microcontroller such that actuation of the at least one first button automatically opens a panel of the armrest and moves the retractable shelf from the stowed configuration to the un-stowed configuration, and
wherein the at least one second button is operably disposed on the at least one retractable shelf and is in operable communication with the microcontroller such that actuation of the at least one second button automatically moves the at least one retractable shelf from the vertical configuration to the horizontal configuration.

12. The retractable shelf system according to claim 11, wherein the hinge assembly comprises:
a pair of movable hinge components each having at least one movable rod;
a stationary component having at least one channel that is configured to receive the at least one movable rod of at least one of the movable hinge components; and
a microelectromechanical system (MEMS) that is in operable communication with the microcontroller and the at least one second button for moving the at least one movable rod of at least one of the movable hinge components into engagement with the at least one channel of the stationary component for locking the retractable shelf in the vertical configuration and moving the at least one movable rod of at least one of the of movable hinge components out of engagement with the at least one channel of the stationary component for unlocking the retractable shelf so that the retractable shelf can be moved from the vertical configuration to the horizontal configuration.

13. The retractable shelf system according to claim 11, wherein the rail assembly comprises a pair of rails each supporting an end of a base member that is operably connected to the hinge assembly of the retractable shelf, and
wherein the base member is movable between the pair of rails along a vertical axis for moving the retractable shelf from the stowed configuration to the un-stowed configuration.

14. The retractable shelf system according to claim 11, further comprising at least one universal serial bus port that is disposed on the retractable shelf.

15. The retractable shelf system according to claim 11, further comprising a plurality of light sources that are arranged around a perimeter of the retractable shelf for illuminating a top surface of the retractable shelf.

16. The retractable shelf system according to claim 11, wherein the microcontroller is configured to detect when the motor vehicle is in motion, and, when the microcontroller detects that the motor vehicle is in motion, disable the retractable shelf system.

17. The retractable shelf system according to claim 11, wherein microcontroller is configured to pair with a smart device for allowing the smart device to control the retractable shelf system.

18. The retractable shelf system according to claim 11, wherein in the horizontal configuration the retractable shelf is configured to detach from the hinge assembly upon a predetermined amount of force being applied to the retractable shelf.
